(19) United States
(12) Patent Application Publication
(10) Pub. No.: US 2023/0225411 A1
(43) Pub. Date: Jul. 20, 2023

(54) AEROSOL-GENERATING DEVICE WITH INDUCTION COIL WITH MOVABLE THIRD CONTACT

(71) Applicant: Philip Morris Products S.A., Neuchatel (CH)

(72) Inventors: Rui Nuno BATISTA, Morges (CH); Ricardo CALI, Mannheim (DE); Toney Moses RAJAN, Mannheim (DE)

(73) Assignee: Philip Morris Products S.A., Neuchatel (CH)

(21) Appl. No.: 17/998,167

(22) PCT Filed: May 7, 2021
(86) PCT No.: PCT/EP2021/062131

§ 371 Date: Nov. 8, 2022

(30) Foreign Application Priority Data
May 14, 2020 (EP) 20174667.4

(51) Int. Cl. A24F 40/465; A24F 40/20; A24F 40/57; H05B 6/10

(52) U.S. Cl. CPC A24F 40/465; A24F 40/20; A24F 40/57; H05B 6/105

(57) ABSTRACT

An aerosol-generating device is provided, including: a heating arrangement including an induction coil, first, second, and third contacts; and a controller, in which the first contact is arranged contacting a proximal end of the induction coil, in which the second contact is arranged contacting a distal end of the induction coil, in which the third contact is arranged contacting the induction coil between the first and the second contacts, in which the first, the second, and the third contacts are electrically connected to the controller, in which the controller is configured to control supply of an alternating electrical current between only a pair of the first, the second, and the third contacts, and in which the first and the second contacts are fixed contacts and the third contact is configured as a movable contact. A method for heating a heating arrangement of an aerosol-generating device is also provided.

The present invention relates to an aerosol-generating device.

It is known to provide an aerosol-generating device for generating an inhalable vapor. Such devices may heat aerosol-forming substrate to a temperature at which one or more components of the aerosol-forming substrate are volatilised without burning the aerosol-forming substrate. Aerosol-forming substrate may be provided as part of an aerosol-generating article. The aerosol-generating article may have a rod shape for insertion of the aerosol-generating article into a cavity, such as a heating chamber, of the aerosol-generating device.

A heating arrangement may be arranged in or around the heating chamber for heating the aerosol-forming substrate once the aerosol-generating article is inserted into the heating chamber of the aerosol-generating device. The heating arrangement may be an induction heating arrangement and comprise an induction coil and a susceptor.

It would be desirable to provide an aerosol-generating device with variable heating of the aerosol-forming substrate of the aerosol-generating article. It would be desirable to provide an aerosol-generating device with variable heating zones. It would be desirable to provide an aerosol-generating device with switchable heating zones. It would be desirable to provide an aerosol-generating device with the option of heating zones or of having a uniform heating of the aerosol-forming substrate of the aerosol-generating article.

According to an embodiment of the invention there is provided an aerosol-generating device. The aerosol-generating device comprises a heating arrangement. The heating arrangement comprises an induction coil, a first contact, a second contact and a third contact. The aerosol-generating device further comprises a controller. The first contact is arranged contacting a proximal end of the induction coil. The second contact is arranged contacting a distal end of the induction coil. The third contact is arranged contacting the induction coil between the first contact and the second contact. The first, second and third contacts are electrically connected to the controller. The controller is configured to control supply of an alternating electrical current between only a pair of the first, second and third contacts. The first contact and the second contact are fixed contacts and the third contact is configured as a movable contact.

According to an embodiment of the invention there may be provided an aerosol-generating device. The aerosol-generating device may comprise a heating arrangement. The heating arrangement may comprise an induction coil, a first contact, a second contact and a third contact. The aerosol-generating device may further comprise a controller. The first contact may be arranged contacting a proximal end of the induction coil. The second contact may be arranged contacting a distal end of the induction coil. The third contact may be arranged contacting the induction coil between the first contact and the second contact. The first, second and third contacts may be electrically connected to the controller. The controller may be configured to control supply of an alternating electrical current between only a pair of the first, second and third contacts. The first contact and the second contact may be fixed contacts and the third contact may be configured as a movable contact.

This heating arrangement enables to establish different heating zones. The aerosol-generating device may further comprise a cavity for receiving an aerosol-generating article comprising aerosol-forming substrate. The inductions coil of the heating arrangement may be arranged at least partly surrounding the cavity. A heating zone is the space of the cavity surrounded by a portion of the induction coil between a pair of contacts. The space of the cavity surrounded by the induction coil between the first contact and the third contact is the first heating zone. The space of the cavity surrounded by the induction coil between the second contact and the third contact is the second heating zone and the space of the cavity surrounded by the induction coil between the first contact and the second contact comprises the first heating zone and the second heating zone and is also referred to as the third heating zone. Due to the controller being configured to supply alternating current between different pairs of the first, second and third contacts, multiple options exist for establishing heating zones. Additionally, due to the fact that the third contact is movable, the size of the heating zones can be modified. The size of the heating zones can be modified during operation by moving the third contact during operation. Alternatively or additionally, the size of the heating zones can be modified between operating the heating arrangement by moving the third contact between operating the heating arrangement.

Exemplarily, if an aerosol-generating article comprising aerosol-forming substrate as described in more detail below is received in the cavity of the aerosol-generating device, it may be desirable to heat a proximal part of the aerosol-forming substrate first. Within the heating arrangement, alternating current may initially be supplied by the controller between the first contact and the third contact. This may lead to an operation of the induction coil such that the first heating zone is operated. The first heating zone is the most proximal heating zone of the heating arrangement. Subsequently, the size of the first heating zone may be increased by moving the third contact in the direction towards the second contact. Finally, the second heating zone of the heating arrangement, being the most distal heating zone of the heating arrangement, may be operated. For operating this second heating zone, the controller may supply alternating current between the second contact and the third contact.

The first, second and third contacts are all electrical contacts. The first and second contacts may be fixed contacts. In other words, the first and second contacts are preferably not movable. The first and second contacts may electrically contact respective distal and proximal ends of the induction coil of a heating arrangement. The first and second contacts may be fixed to the ends of the induction coil by any known means, exemplarily by soldering.

In contrast to the first and second contacts, the third contact is a movable contact. The third contact may be movably mounted. The third contact may be mounted on a sliding arrangement.

The sliding arrangement may be arranged adjacent the induction coil and configured to slide parallel to the longitudinal axis of the aerosol-generating device and parallel to the induction coil. The third contact of the heating arrangement may be mounted on the sliding arrangement. An electrical contact point between the third contact and the induction coil may be adaptable by sliding the sliding arrangement.

The sliding arrangement may be at least partly electrically conductive. This may enable supply of alternating current to the third contact via the sliding arrangement. The controller may be electrically connected with the sliding arrangement. The controller may be electrically connected with the first contact. The controller may be electrically connected with the second contact. The controller may be electrically connected with the third contact via the sliding arrangement.

The sliding arrangement may be longitudinal. The sliding arrangement may be arranged parallel to the longitudinal axis of the cavity. The sliding arrangement may be arranged parallel to the heating arrangement. The sliding arrangement may be rod-shaped. The sliding arrangement may comprise a motor. The controller may be configured to control operation of the motor. The motor may be an electric motor. The motor may be a linear motor. A change of shape of the heating zones of the heating arrangement may be facilitated by the controller operating movement of the sliding arrangement by operation of the motor. The third contact may be securely mounted on the sliding arrangement. In other words, the third contact may be mounted on the sliding arrangement such that the third contact is fixed on the sliding arrangement. The sliding arrangement may be configured to slide in the axial direction of the sliding arrangement. The axial direction of the sliding arrangement may be parallel to the longitudinal axis of the cavity. The longitudinal axis of the cavity may be identical or parallel to the longitudinal axis of the heating arrangement. The longitudinal axis of the heating arrangement may be identical or parallel to the longitudinal axis of the aerosol generating device.

The controller may be configured to control supply of an alternating electrical current between the first contact and the third contact such that the portion of the induction coil surrounding the first heating zone creates an alternating magnetic field.

The controller may be configured to control supply of an alternating electrical current between the second contact and the third contact such that the portion of the induction coil surrounding the second heating zone creates an alternating magnetic field.

The controller may be configured to control supply of an alternating electrical current between the first contact and the second contact such that the induction coil surrounding both the first heating zone and the second heating zone creates an alternating magnetic field.

The controller may be configured to control supply of an alternating electrical current between a first pair of the first, second and third contacts for a first predetermined time and to control supply of an alternating electrical current between a different second pair of the first, second and third contacts for a second predetermined time. In other words, the controller may be configured to heat one or more of the first, second and third heating zones for one or both of the first and second predetermined time. Exemplarily, the controller may be configured to supply an alternating electrical current between the first contact and the third contact to heat the first heating zone for the first predetermined time. Exemplarily, the controller may be configured to supply an alternating electrical current between the second contact and the third contact to heat the second heating zone for the second predetermined time. The first and second predetermined times may be chosen such that the aerosol-forming substrate arranged in the respective heating zone is depleted to a desired degree in these predetermined times.

The aerosol-generating device may comprise a motor for moving the movable third contact. The motor may be configured to move the sliding arrangement as described herein. Alternatively, the motor may be configured to directly move the third contact. The motor may be an electric motor. The motor may be a linear motor. The motor may be configured to move the third contact parallel to the longitudinal axis of the induction coil. The controller may be configured to control operation of the motor. The controller may be configured to operate operation of the motor according to a predetermined operation regime. The predetermined operation regime may be chosen by the user. The predetermined operation regime may depend upon the aerosol-forming substrate of the aerosol-generating article to be used with the aerosol-generating device. The predetermined operation regime may comprise one or both of the first predetermined time and the second predetermined time.

The aerosol-generating device may comprise an actuator configured to enable a user to manually move the movable third contact. The actuator may comprise a button or knob on the outer surface of the aerosol generating device. The button may enable a user to contact the button and to slide the button parallel to the longitudinal axis of the aerosol-generating device. Sliding the button may lead to the actuator sliding parallel to the longitudinal axis of the aerosol generating device. The sliding action of the actuator may delete to the movement, particularly the sliding action, of the third contact.

The induction coil may be a helical coil and the movable third contact may be configured to move axially along the induction coil. The third contact may be configured as a sliding contact. The electrical contact point between the induction coil and the third contact may be moved together with the movement of the third contact. The third contact may be configured to maintain electrical contact with the induction coil during movement of the third contact.

The third contact may be configured to modify the effective operation length of the induction coil upon movement of the movable third contact. The effective operation length of the induction coil may be the part of the induction coil through which alternating electrical current runs when the alternating current is supplied to the induction coil. Exemplarily, if electrical an alternating current is supplied between the first contact and the third contact, the effective operation length of the induction coil may be the longitudinal length of the induction coil between the first contact and the third contact and correspondingly for the second contact and the third contact. The effective operation length of the induction coil may correspond to the longitudinal length of the heating zone being operated.

The aerosol-generating device may comprise a communication interface enabling a user to control operation of the controller. The communication interface may be configured as a display. The communication interface may be configured as a touch display. The communication interface may comprise a wireless technology to enable communication of the communication interface with an external device such as a smartphone, smartwatch or tablet. The communication interface may be configured as or comprise a button. By means of the communication interface, a user may control operation of the controller. Exemplarily, a user may control operation of the movement of the sliding arrangement. As a consequence, a user may change the size of the heating zones within the heating arrangements.

The third contact may movable only unidirectionally during one operation cycle of the aerosol-generating device. One operation cycle of the aerosol-generating device corresponds to the process of depleting a fresh aerosol-generating article. In this way, the aerosol-forming substrate of an aerosol-generating article inserted into the cavity of the aerosol-generating device may be uniformly heated starting from one end of the aerosol-forming substrate to the other end of the aerosol-forming substrate. No portion of the aerosol-forming substrate is in this case be heated twice or for a time longer than the desired time for heating this portion of the aerosol-forming substrate. Preferably, the third contact is movable only unidirectionally in a distal direction during one operation cycle of the aerosol generating device. As a consequence, the aerosol-forming substrate of the aerosol-generating article that is heated its initially heated at a proximal portion and subsequently the more distal parts of the aerosol-forming substrate are heated.

The aerosol-generating device may comprise electric circuitry. The electric circuitry may comprise a microprocessor, which may be a programmable microprocessor. The microprocessor may be part of the controller. The electric circuitry may comprise further electronic components. The electric circuitry may be configured to regulate a supply of power to the heating arrangement. Power may be supplied to the heating arrangement continuously following activation of the aerosol-generating device or may be supplied intermittently, such as on a puff-by-puff basis. The power may be supplied to the heating arrangement in the form of pulses of an alternating electrical current. The electric circuitry may be configured to monitor the electrical resistance of the heating arrangement, and preferably to control the supply of power to the heating arrangement dependent on the electrical resistance of the heating arrangement.

The aerosol-generating device may comprise a power supply, typically a battery, within a main body of the aerosol-generating device. In one embodiment, the power supply is a Lithium-ion battery. Alternatively, the power supply may be a Nickel-metal hydride battery, a Nickel cadmium battery, or a Lithium based battery, for example a Lithium-Cobalt, a Lithium-Iron-Phosphate, Lithium Titanate or a Lithium-Polymer battery. As an alternative, the power supply may be another form of charge storage device such as a capacitor. The power supply may require recharging and may have a capacity that enables to store enough energy for one or more usage experiences; for example, the power supply may have sufficient capacity to continuously generate aerosol for a period of around six minutes or for a period of a multiple of six minutes. In another example, the power supply may have sufficient capacity to provide a predetermined number of puffs or discrete activations of the heating arrangement.

As used herein, an ‘aerosol-generating device’ relates to a device that interacts with an aerosol-forming substrate to generate an aerosol. The aerosol-forming substrate may be part of an aerosol-generating article, for example part of a smoking article. An aerosol-generating device may be a smoking device that interacts with an aerosol-forming substrate of an aerosol-generating article to generate an aerosol that is directly inhalable into a user's lungs thorough the user's mouth. An aerosol-generating device may be a holder. The device may be an electrically heated smoking device. The aerosol-generating device may comprise a housing, electric circuitry, a power supply, a heating chamber and heating arrangement.

As used herein, the term ‘aerosol-generating article’ refers to an article comprising an aerosol-forming substrate that is capable of releasing volatile compounds that can form an aerosol. For example, an aerosol-generating article may be a smoking article that generates an aerosol that is directly inhalable into a user's lungs through the user's mouth. An aerosol-generating article may be disposable.

The induction heating arrangement comprises the induction coil and the susceptor. In general, a susceptor is a material that is capable of generating heat, when penetrated by an alternating magnetic field. When located in an alternating magnetic field. If the susceptor is conductive, then typically eddy currents are induced by the alternating magnetic field. If the susceptor is magnetic, then typically another effect that contributes to the heating is commonly referred to hysteresis losses. Hysteresis losses occur mainly due to the movement of the magnetic domain blocks within the susceptor, because the magnetic orientation of these will align with the magnetic induction field, which alternates. Another effect contributing to the hysteresis loss is when the magnetic domains will grow or shrink within the susceptor. Commonly all these changes in the susceptor that happen on a nano-scale or below are referred to as “hysteresis losses”, because they produce heat in the susceptor. Hence, if the susceptor is both magnetic and electrically conductive, both hysteresis losses and the generation of eddy currents will contribute to the heating of the susceptor. If the susceptor is magnetic, but not conductive, then hysteresis losses will be the only means by which the susceptor will heat, when penetrated by an alternating magnetic field. According to the invention, the susceptor may be electrically conductive or magnetic or both electrically conductive and magnetic. An alternating magnetic field generated by one or several induction coils heat the susceptor, which then transfers the heat to the aerosol-forming substrate, such that an aerosol is formed. The heat transfer may be mainly by conduction of heat. Such a transfer of heat is best, if the susceptor is in close thermal contact with the aerosol-forming substrate. The susceptor may be arranged within the cavity or surrounding the cavity. The susceptor may be pin-shaped. The susceptor may be blade-shaped. If the susceptor is pin or blade-shaped, the susceptor is preferably arranged centrally within the cavity of the aerosol generating device. If an aerosol-generating article is inserted into the cavity of the aerosol-generating device, the susceptor may then penetrate into the aerosol-forming substrate of the aerosol-generating article.

Alternatively or additionally, the susceptor may be arranged at least partly surrounding the cavity of the aerosol-generating device. The susceptor may fully surround the cavity of the aerosol-generating device. The inner diameter of such a susceptor arrangement may correspond to or be slightly smaller than the outer diameter of an aerosol-generating article to be received within the cavity. If the aerosol-generating article is inserted into the cavity, the outer circumference of the aerosol-generating article may contact the susceptor. Consequently, the susceptor may hold the aerosol-generating article in the cavity. The susceptor may form the inner wall of the cavity.

The invention may further relate to a system comprising an aerosol-generating device as described herein and an aerosol-generating article comprising aerosol-forming substrate.

The invention further relates to a method for heating a heating arrangement of an aerosol-generating device, the method comprising the following steps:

providing an aerosol-generating device as described herein;

supplying an alternating electrical current only between the first contact and the third contact for a predetermined time;

moving the third contact while supplying an alternating electrical current only between the first contact and the third contact; and

supplying an alternating electrical current only between the third contact and the second contact for a predetermined time.

During movement of the third contact, the third contact may be moved in the direction of the second contact. The third contact may be configured to be only unidirectionally movable in the direction of the second contact during one operation cycle of the aerosol-generating device. The movement direction towards the second contact may be a distal direction.

The invention further relates to a susceptor for a heating arrangement as described herein of an aerosol-generating device as described herein. The susceptor comprises a ceramic substrate. The susceptor further comprises multiple metal strips comprising susceptor material. The metal strips are arranged on the ceramic substrate. The metal strips are electrically insulated from each other.

The invention may further relate to a susceptor for a heating arrangement of an aerosol-generating device. The susceptor may comprise a ceramic substrate. The susceptor may comprise multiple metal strips comprising susceptor material. The metal strips may be arranged on the ceramic substrate. The metal strips may be electrically insulated from each other.

Providing multiple independent metal strips results in optimized induction heating. In this regard, the different heating zones as described above with respect to the operation of the heating arrangement and the movable third contact may necessitate that the susceptor is not heated uniformly over its whole longitudinal length. Particularly, the longitudinal length of the induction coil corresponding to the third heating zone may correspond to the longitudinal length of the susceptor. The longitudinal length of the first heating zone and the longitudinal length of the second heating zone may however be smaller than the length of the susceptor. By providing the metal strips, the susceptor is only or predominantly heated in the area of the metal strips arranged in the respective heating zone that is operated. The adjacent metal strips are not inductively heated or heated inductively to a lesser degree in adjacent areas which are not or to a lesser degree subjected to the alternating magic field of the operated part of the induction coil.

In addition to the electrical insulation between the metal strips, the metal strips may also be thermally insulated from each other. Between the metal strips, an insulating foil or an insulating layer may be provided.

The susceptor may be arranged within the cavity or surrounding the cavity. The ceramic substrate of the susceptor may be pin-shaped. The ceramic substrate of the susceptor may be blade-shaped. If the susceptor is pin or blade-shaped, the susceptor is preferably arranged centrally within the cavity of the aerosol generating device. If an aerosol-generating article is inserted into the cavity of the aerosol-generating device, the susceptor may then penetrate into the aerosol-forming substrate of the aerosol-generating article.

On the outer surface of the susceptor, a protection layer, preferably a protection layer made from glass, may be provided.

The metal strips may be elongate. The metal strips may be tangentially wrapped around the ceramic substrate. One metal strip, preferably the majority of the metal strips, more preferably each metal strip, may be arranged tangentially wound around the ceramic substrate.

The metal strips may have a hollow cylindrical shape. The metal strips may be configured suitable to be heated in the alternating magnetic field of the induction coil. In other words, the metal strips are made from a material suitable for induction heating.

The metal strips may be arranged side by side along a longitudinal axis of the susceptor.

One metal strip, preferably the majority of metal strips, more preferably each metal strip has a width that may be at most 20%, preferably at most 10%, more preferably at most 5%, of the longitudinal length of the susceptor.

Features described in relation to one embodiment may equally be applied to other embodiments of the invention.

Below, there is provided a non-exhaustive list of non-limiting examples. Any one or more of the features of these examples may be combined with any one or more features of another example, embodiment, or aspect described herein.

Example A: Aerosol-generating device comprising:

A heating arrangement, the heating arrangement comprising an induction coil, a first contact, a second contact and a third contact; and

a controller,

wherein the first contact is arranged contacting a proximal end of the induction coil, wherein the second contact is arranged contacting a distal end of the induction coil, wherein the third contact is arranged contacting the induction coil between the first contact and the second contact, wherein the first, second and third contacts are electrically connected to the controller, wherein the controller is configured to control supply of an alternating electrical current between only a pair of the first, second and third contacts, and wherein the first contact and the second contact are fixed contacts and the third contact is configured as a movable contact.

Example B: Aerosol-generating device according to example A, wherein the aerosol-generating device further comprises a cavity for receiving an aerosol-generating article comprising aerosol-forming substrate, and wherein the induction coil of the heating arrangement is arranged at least partly surrounding the cavity.

Example C: Aerosol-generating device according to example B, wherein the space of the cavity surrounded by a portion of the induction coil between the first contact and the third contact is a first heating zone, wherein the space of the cavity surrounded by a portion of the induction coil between the second contact and the third contact is a second heating zone, and wherein the space of the cavity surrounded by the induction coil between the first contact and the second contact comprises the first heating zone and the second heating zone.

Example D: Aerosol-generating device according to example C, wherein the controller is configured to control supply of an alternating electrical current between the first contact and the third contact such that the portion of the induction coil surrounding the first heating zone creates an alternating magnetic field in the first heating zone.

Example E: Aerosol-generating device according to example C or D, wherein the controller is configured to control supply of an alternating electrical current between the second contact and the third contact such that the portion of the induction coil surrounding the second heating zone creates an alternating magnetic field in the second heating zone.

Example F: Aerosol-generating device according to any of examples C to E, wherein the controller is configured to control supply of an alternating electrical current between the first contact and the second contact such that the induction coil surrounding both the first heating zone and the second heating zone creates an alternating magnetic field in both the first and second heating zone.

Example G: Aerosol-generating device according to any of the preceding examples, wherein the controller is configured to control supply of an alternating electrical current between a first pair of the first, second and third contacts for a first predetermined time and to control supply of an alternating electrical current between a different second pair of the first, second and third contacts for a second predetermined time.

Example H: Aerosol-generating device according to any of the preceding examples, wherein the aerosol-generating device comprises a motor for moving the movable third contact.

Example I: Aerosol-generating device according to any of the preceding examples, wherein the aerosol-generating device comprises an actuator configured to enable a user to manually move the movable third contact.

Example J: Aerosol-generating device according to any of the preceding examples, wherein the induction coil is a helical coil and the movable third contact is configured to move axially along the induction coil.

Example K: Aerosol-generating device according to example J, wherein the third contact is configured to modify the effective operation length of the induction coil upon movement of the movable third contact.

Example L: Aerosol-generating device according to any of the preceding examples, wherein the controller is configured to operate movement of the movable third contact.

Example M: Aerosol-generating device according to any of the preceding examples, wherein the movable third contact is configured as a sliding contact.

Example N: Aerosol-generating device according to any of the preceding examples, wherein the aerosol-generating device comprises a communication interface enabling a user to control operation of the controller.

Example O: Method for heating a heating arrangement of an aerosol-generating device comprising a heating arrangement and a controller, the heating arrangement comprising an induction coil, a fixed first contact, a fixed second contact and a movable third contact, wherein the first contact is arranged contacting a proximal end of the induction coil, wherein the second contact is arranged contacting a distal end of the induction coil, wherein the third contact is arranged contacting the induction coil between the first contact and the second contact, wherein the first, second and third contacts are electrically connected to the controller, wherein the controller is configured to control supply of an alternating electrical current between only a pair of the first, second and third contacts; the method comprising the following steps:

supplying the alternating electrical current only between the first contact and the third contact for a predetermined time; and then

moving the third contact while supplying the alternating electrical current only between the first contact and the third contact; and then

supplying the alternating electrical current only between the first contact and the second contact for a predetermined time. Example P: Method of example 0, wherein, during movement of the third contact, the third contact is moved in the direction towards the second contact.

Example Q: Susceptor for a heating arrangement of an aerosol-generating device,

the susceptor comprising:

a ceramic substrate; and

multiple metal strips comprising susceptor material,

wherein the metal strips are arranged on the ceramic substrate, and wherein the metal strips are electrically insulated from each other.

Example R: Susceptor according to example Q, wherein the metal strips are elongate.

Example S: Susceptor according to any of examples Q or R, wherein the metal strips are arranged side by side along a longitudinal axis of the susceptor.

Example T: Susceptor according to any of examples Q to S, wherein one metal strip, preferably the majority of metal strips, more preferably each metal strip is arranged tangentially wound around the ceramic substrate.

Example U: Susceptor according to any of examples Q to T, wherein one metal strip, preferably the majority of metal strips, more preferably each metal strip has a width that is at most 20%, preferably at most 10%, more preferably at most 5%, of the longitudinal length of the susceptor.

Example V: Susceptor according to any of examples Q to U, wherein the susceptor is pin or blade shaped.

Example W: Susceptor according to any of examples Q to V, wherein the susceptor is tubular.

The invention will be further described, by way of example only, with reference to the accompanying drawings in which:

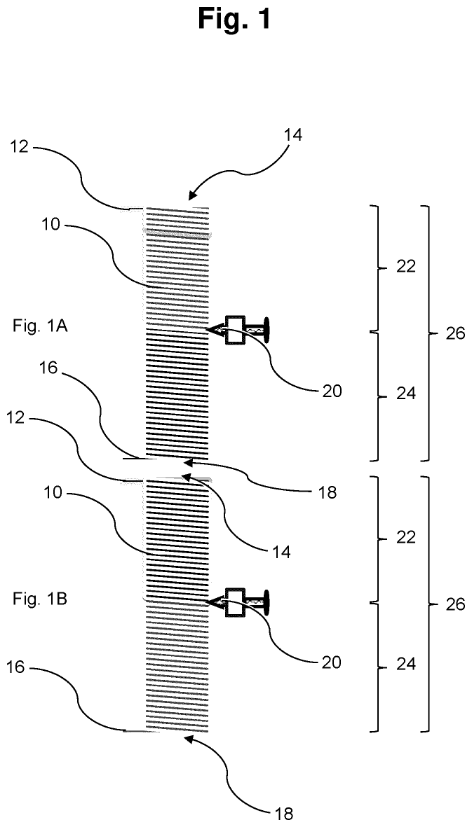

FIG. 1 shows first, second and third contacts and an induction coil of a heating arrangement of an aerosol-generating device according to the invention;

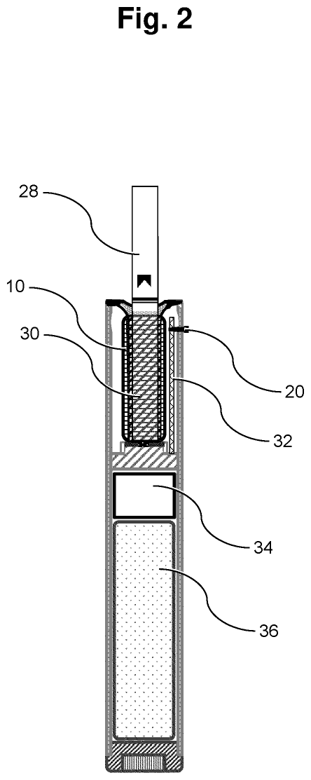

FIG. 2 shows the aerosol-generating device;

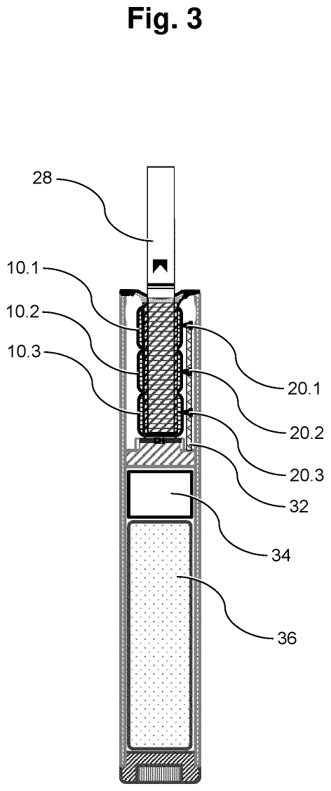

FIG. 3 shows a further embodiment of the aerosol-generating device; and

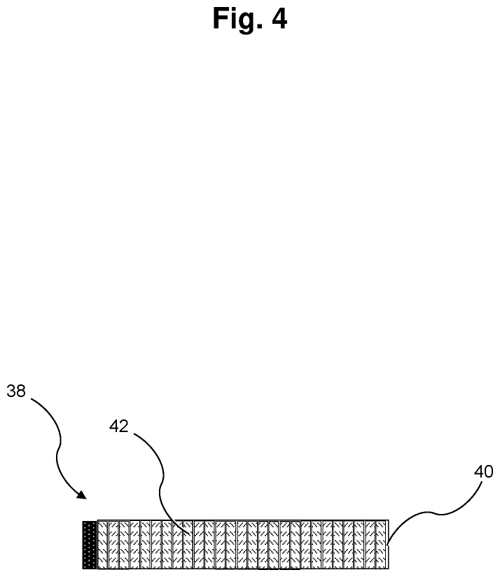

FIG. 4 shows a susceptor to be used in the heating arrangement.

FIG. 1 shows parts of a heating arrangement of an aerosol-generating device. The heating arrangement comprises an induction coil. The induction coil 10 is configured to generate an alternating magnetic field to heat a susceptor. The susceptor is surrounded by the induction coil 10 and not shown in FIG. 1. The induction coil 10 is electrically contacted such that alternating current can be supplied to the induction coil. The energy is supplied in the form of an AC current.

A first contact 12 is provided and arranged to contact the induction coil 10 at a proximal end 14 of the induction coil. A second contact 16 is provided and arranged to contact the induction coil 10 at a distal end 18 of the induction coil. A third contact 20 is provided and arranged to contact the induction coil 10 between the first contact 12 and the second contact 16. The first contact 12 and the second contact 16 are fixed contacts. These contacts do not move and are fixed to the induction coil 10 exemplarily by soldering. The third contact 20 is configured as a movable contact. The third contact 20 is configured to move in an axial direction parallel to the longitudinal axis of the induction coil. The third contact 20 is configured as a sliding contact. The third contact 20 is configured to create an electrical contact point to the induction coil.

FIG. 1A in the upper part of FIG. 1 shows a first option of option for operating the heating arrangement. Alternating current is supplied only between a pair of the contacts. Generally, alternating current is supplied between a pair of the first contact 12, the second contact 16 and the third contact. In the example shown in FIG. 1A, alternating current is supplied between the second contact 16 and the third contact. The area surrounded by the induction coil 10 between the second contact 16 and the third contact 20 is referred to as the second heating zone 24. The area surrounded by the induction coil 10 between the first contact 12 and the third contact 20 is referred to as the first heating zone 22. The area surrounded by the induction coil 10 between the first contact 12 and the second contact 16 is referred to as the third heating zone 26. In the example shown in FIG. 1A, only the second heating zone 24 is operated, since alternating current is supplied only between the second contact 16 and the third contact. This mode of operation may be chosen at any point during the operation cycle of the aerosol-generating device. The operation cycle of the aerosol-generating device may denote the process of depleting the aerosol-forming substrate of an aerosol-forming article.

FIG. 1B in the lower part of FIG. 1 shows a second option for operating the heating arrangement. In contrast to FIG. 1A, alternating current is supplied between the first contact 12 and the third contact 20 to heat the first heating zone 22.

FIG. 2 shows the aerosol-generating device. The aerosol generating device comprises a cavity 30 for receiving the aerosol-generating article 28 comprising the aerosol-forming substrate. The heating arrangement, particularly the induction coil 10 of the heating arrangement, is arranged surrounding the cavity 30. The third contact 20 is mounted on a sliding arrangement 32. By means of the sliding arrangement 32, the third contact 20 is made movable. The movement of the third contact 20 is enabled in a direction parallel to the longitudinal axis of the induction coil 10 such that the movable contact can establish a different axial electrical contact point to the induction coil.

FIG. 2 further shows a controller 34. The controller 34 is electrically connected with the third contact 20 via the sliding arrangement 32. The controller 34 is electrically connected with the first contact 12. The controller 34 is electrically connected with the second contact 16. The controller 34 is configured to control supply of alternating current from a power supply in the form of a battery 36 to the induction coil 10 via the first contact 12, the second contact 16 and the third contact. The controller 34 is configured to supply alternating current only to a pair of the first contact 12, the second contact 16 and the third contact.

The controller 34 is further configured to control operation of the sliding arrangement 32. The controller 34 is configured to control movement of the third contact 20 via the sliding arrangement 32. The aerosol-generating device may further comprise a motor for moving the sliding arrangement 32. The controller 34 is configured to control operation of the motor. Alternatively, the aerosol-generating device may comprise a manual actuator such that a user can move the sliding arrangement 32.

FIG. 3 shows a further embodiment in which multiple heating arrangements are provided. The heating arrangements are arranged side by side parallel to the longitudinal axis of the aerosol-generating device. Each heating arrangement is configured as the heating arrangement described in conjunction with FIGS. 1 and 2. As a consequence, multiple induction coils 10.1, 10.2, 10.3 are provided and multiple third contacts 20.1, 20.2, 20.3. In the embodiment shown in FIG. 3, all of the third contacts 20.1, 20.2, 20.3 are mounted on the same sliding arrangement 32. Thus, all of these third contacts 20.1, 20.2, 20.3 are moved at the same time. The size of the heating zones of the respective heating arrangements are as a consequence changed in an identical fashion. Alternatively, one or more of the third contacts 20.1, 20.2, 20.3 may be separately mounted on a separate sliding arrangement 32 to allow separate adjustment of the heating zones of the heating arrangement. The controller 34 may be configured to control supply of alternating current between pairs of the contacts of all of the heating arrangements in the same way and at the same time. Alternatively, the controller 34 may be configured to control supply of alternating current between pairs of the contacts of the separate heating arrangements as desired. Exemplarily, the controller 34 may supply alternating current only to one of the heating arrangements and not to the other heating arrangements or to some heating arrangements and not to other heating arrangements.

FIG. 4 shows a susceptor 38 that can be used in the heating arrangement. The susceptor 38 comprises a ceramic substrate 40. The ceramic substrate 40 of the susceptor 38 is pin-shaped. The susceptor 38 can be arranged centrally along the longitudinal axis of the aerosol-generating device and is configured for penetrating into the aerosol-generating article 28 when the aerosol-generating article 28 is inserted into the cavity 30. The ceramic substrate 40 is tangentially wrapped with metal strips 42. The metal strips 42 are made from a material suitable for induction heating. The susceptor 38 is optimized for operation with the different heating zones 22, 24, 26. Preferably, each heating zone 22, 24, 26 will cover multiple metal strips 42. Only or predominantly the metal strips 42 within a heating zone 22, 24, 26 will be heated when the heating zone 22, 24, 26 is operated, since the metal strips 42 are configured electrically isolated from each other. The metal strips 42 may also be thermally insulated from each other by an insulating foil or insulating layer.

Instead of the susceptor 38 shown in FIG. 4, a tubular metal susceptor is preferably employed. The tubular susceptor is hollow and has a shape that the aerosol-generating article 28 can be inserted into the tubular susceptor and be held within the tubular susceptor. The tubular susceptor may form the inner wall of the cavity 30.

1.-15. (canceled)

16. An aerosol-generating device, comprising:
a heating arrangement comprising an induction coil, a first contact, a second contact, and a third contact; and
a controller,
wherein the first contact is arranged contacting a proximal end of the induction coil,
wherein the second contact is arranged contacting a distal end of the induction coil,
wherein the third contact is arranged contacting the induction coil between the first contact and the second contact,
wherein the first, the second, and the third contacts are electrically connected to the controller,
wherein the controller is configured to control supply of an alternating electrical current between only a pair of the first, the second, and the third contacts, and
wherein the first contact and the second contact are fixed contacts and the third contact is configured as a movable contact.

17. The aerosol-generating device according to claim 16,
further comprising a cavity configured to receive an aerosol-generating article comprising an aerosol-forming substrate,
wherein the induction coil of the heating arrangement is arranged at least partly surrounding the cavity.

18. The aerosol-generating device according to claim 17,
wherein a space of the cavity surrounded by a portion of the induction coil between the first contact and the third contact is a first heating zone,
wherein a space of the cavity surrounded by a portion of the induction coil between the second contact and the third contact is a second heating zone, and
wherein a space of the cavity surrounded by the induction coil between the first contact and the second contact comprises the first heating zone and the second heating zone.

19. The aerosol-generating device according to claim 18, wherein the controller is further configured to control supply of the alternating electrical current between the first contact and the third contact such that the portion of the induction coil surrounding the first heating zone creates an alternating magnetic field in the first heating zone.

20. The aerosol-generating device according to claim 18, wherein the controller is further configured to control supply of the alternating electrical current between the second contact and the third contact such that the portion of the induction coil surrounding the second heating zone creates an alternating magnetic field in the second heating zone.

21. The aerosol-generating device according to claim 18, wherein the controller is further configured to control supply of the alternating electrical current between the first contact and the second contact such that the induction coil surrounding both the first heating zone and the second heating zone creates an alternating magnetic field in both the first and the second heating zones.

22. The aerosol-generating device according to claim 16, wherein the controller is further configured to control supply of the alternating electrical current between a first pair of the first, the second, and the third contacts for a first predetermined time, and to control supply of the alternating electrical current between a different second pair of the first, the second, and the third contacts for a second predetermined time.

23. The aerosol-generating device according to claim 16, further comprising a motor configured to move the movable third contact.

24. The aerosol-generating device according to claim 16, further comprising an actuator configured to enable a user to manually move the movable third contact.

25. The aerosol-generating device according to claim 16, wherein the induction coil is a helical coil and the movable third contact is configured to move axially along the induction coil.

26. The aerosol-generating device according to claim 16, wherein the controller is further configured to operate movement of the movable third contact.

27. The aerosol-generating device according to claim 16, wherein the movable third contact is configured as a sliding contact.

28. The aerosol-generating device according to claim 16, further comprising a communication interface configured to enable a user to control operation of the controller.

29. A method for heating a heating arrangement of an aerosol-generating device comprising a heating arrangement and a controller, the heating arrangement comprising an induction coil, a fixed first contact, a fixed second contact, and a movable third contact, the first contact being arranged contacting a proximal end of the induction coil, the second contact being arranged contacting a distal end of the induction coil, the third contact being arranged contacting the induction coil between the first contact and the second contact, the first, the second, and the third contacts being electrically connected to the controller, and the controller being configured to control supply of an alternating electrical current between only a pair of the first, the second, and the third contacts, the method comprising the following steps:
supplying the alternating electrical current only between the first contact and the third contact for a predetermined time; and then
moving the third contact while supplying the alternating electrical current only between the first contact and the third contact; and then
supplying the alternating electrical current only between the first contact and the second contact for another predetermined time.

30. The method according to claim 29, wherein, during movement of the third contact, the third contact is moved in a direction towards the second contact.
